(19) United States
(12) Patent Application Publication
(10) Pub. No.: US 2008/0266260 A1
(43) Pub. Date: Oct. 30, 2008

(54) Apparatus Having Handwriting and Mouse Input Functions

(75) Inventors: Yingjian Liu, Beijing (CN); Changping Liu, Beijing (CN); Honggang Wang, Beijing (CN); Hongxiao Wu, Beijing (CN)

Correspondence Address: PEACOCK MYERS, P.C., 201 THIRD STREET, N.W., SUITE 1340, ALBUQUERQUE, NM, 87102, US

(73) Assignee: HANWANG TECHNOLOGY CO., LTD., Beijing (CN)

(21) Appl. No.: 11/910,112

(22) PCT Filed: Nov. 11, 2005
(86) PCT No.: PCT/CN05/01908

§ 371 Date: Jul. 21, 2008

(30) Foreign Application Priority Data
Mar. 30, 2005 (CN) 200510058837.2

(51) Int. Cl. G06F 3/033

(52) U.S. Cl. 345/166; 345/179

(57) ABSTRACT

An apparatus having handwriting input and the mouse functions is an external input device of computer field. A handwriting screen is amounted inside a mouse body, and the handwriting screen is connected to a processor. An optical displacement sensor is connected to the processor or can also be located therein. USB interface unit is connected to the processor or can also be located therein. The optical displacement sensor is used to acquire relative coordinate information when the apparatus moves, and the handwriting screen is used to acquire handwriting trace information. The processor is directly connected to USB external interface of the computer through its connection or its embedded USB interface unit to establish a communication. The present invention relates to a structure of the apparatus divided into two parts, i.e. the mouse and the handwriting screen. The present invention has both the mouse and the handwriting input functions, and can implement the mouse and the handwriting input operation at any moment while employ a resistance screen to prevent influence of humidity. Its structural design is reasonable, so its operation is convenient, its bulk is small, and it can be carried conveniently.

### FIELD OF THE INVENTION

The present invention relates to an apparatus having handwriting input and mouse functions, which belongs to the peripheral input device of computer field.

### BACKGROUND OF THE INVENTION

The computer is one of the most important scientific achievements in the human history of science and technology development, now it has been applied widely. The input device is indispensable for computers, and serves to provide the host computer with instructions and data. In the early time, the mouse has become the normal external input device of the computer's configuration, that is, basically each computer is equipped with a mouse. In addition, there are several main input devices, such as the keyboard, handwriting screen, scanner, digitizer, handwriting tablet and so on, in which the handwriting tablet has currently been widely used, making it more convenient for handwriting font inputting and those computer users who have trouble with the use of keyboard. It could be predicted that more than 10% of computer users equip their computers with handwriting tablets or other input devices in addition to the keyboard and the mouse. Consequently, there are at least three external input devices of computer, which involves the keyboard, the mouse and the handwriting tablet. Too many input devices add burden of cost on the user, furthermore, they occupy users' desktop space and computer's interface resources, and bring more inconveniences for users to carry, especially for the users having notebook computers. Therefore, the development for computer peripheral devices is oriented to integration, minimization and intelligentization.

Moreover, at present, the mouse on market is only specialized in cursor-controlling and webpage-browsing, while few are entitled with handwriting input. For example, MPTR handwriting board of optical induction mouse type, made by CTT company, i.e. Cybertouch-tech Int. Co. Ltd., is structured with a capacitance-sensing means attached to the mouse housing. This kind of device can detect the specific position by means of the capacitance change of users' fingers when users use the device. It is characterized by enabling users to operate directly with their fingers, while its drawbacks exist in its extreme sensitivity to humidity and less precision. Further, it is necessary to analyze whether the mouse or the handwriting capacitance touch screen is working before the function switch is completed between the mouse and the handwriting, which will lead to time delay and the possible error judgements during the operation. In addition, the present handwriting tablets are accompanied with some cursor positioning and controlling functions like a mouse, but their appearances are shaped as handwriting tablet profile, the easiness to use and convenience is far less than a mouse, so the practicability of that functions is not strong. To sum up, so far there has never been a computer external input device that integrates the easiness, convenience and accuracy of a mouse, and performs handwriting input at any moment without switching.

### SUMMARY OF THE INVENTION

To solve the above technical problems, the present invention aims to provide a computer external input device that incorporates the easiness, convenience and accuracy of a mouse, and performs handwriting input at any moment without switching.

The technical aspect of the present invention is as the follows. A handwriting screen is arranged in a mouse and the handwriting screen is connected to a processor in the mouse. An optical displacement sensor is connected to the processor, or may be also built in the processor. A USB interface unit is connected to the processor, or may be also built in the processor.

As a preferred aspect of the present invention, the detailed connection relation among the optical displacement sensor, the handwriting screen, the processor and the USB interface unit is shown in FIG. 1. The optical displacement sensor and the handwriting screen are connected to the processor, respectively. The USB interface unit is embedded in the processor. The processor is directly connected to a USB external interface of the computer through the USB interface unit to establish a communication.

As a second aspect of the present invention, the detailed connection relation between the optical displacement sensor, the handwriting screen, a processor and the USB interface unit is shown in FIG. 2. The handwriting screen is directly connected to the processor, and the optical displacement sensor is built in the processor that is embedded with the USB interface unit. The processor is directly connected to a USB external interface of the computer through the USB interface unit to establish a communication.

As a third aspect of the present invention shown in FIG. 3, two processors and a USB hub are provided. The two processors respectively process signals transmitted by an optical displacement sensor and a handwriting screen. The handwriting screen is connected to one of the processors in which a USB interface unit is located. The optical displacement sensor is connected to the other processor in which a USB interface unit is located. Both of the two processors are also connected respectively to a USB hub, which is connected to a USB external interface of the computer so as to establish a communication.

According to the apparatus of the present invention, the handwriting screen arranged in the mouse may be either covered with a handwriting screen lid or exposed. A handwriting stylus may be disposed in the handwriting screen lid and on both sides of the mouse.

According to the apparatus of the present invention, a structural body is divided into two parts including a mouse and a handwriting screen, respectively. The handwriting screen may be arranged inside the mouse. The mouse can be designed to be of a flip-over cover type and pullout type, that is, to fix the handwriting screen on the inner side of the flip-over cover. The handwriting screen can also be fixed on the sliding track to form a pullout handwriting screen.

The handwriting screen provided in a mouse is resistance composition screen, which is composed of two conductive layers and the isolating substance between them.

With the present invention apparatus having above structure, the advantages may be obtained as follows. It has both the mouse and handwriting input functions. It can implement the mouse or the handwriting input operation at any moment, and the computer processor is not required to make an operating judgment and wait for function switching, therefore resulting in no mutual interference and the time delay. Also, it employs a resistance screen to prevent the influence of humidity. Moreover, it is reasonably designed in structure, so it is convenient, accurate and rapid to operate as well as a small bulk to be easily carried.

### DESCRIPTION OF THE DRAWINGS

FIG. 1 is a system schematic diagram of the preferred aspect of the present inventive apparatus.

FIG. 2 is a system schematic diagram of the second aspect of the present inventive apparatus.

FIG. 3 is a system schematic diagram of the third aspect of the present inventive apparatus.

FIG. 4 is a profile effect diagram of the apparatus described in the present invention.

FIG. 5 is a diagram showing the effect of the using state of the apparatus described in the present invention.

FIG. 6 is a structural sectional diagram of the structure of the apparatus described in the present invention.

FIG. 7 is a circuit diagram of the preferred aspect of the present inventive apparatus.

### NUMERIC MARKS

1—mouse body

2—handwriting stylus

3—handwriting screen

4—handwriting screen lid

5—conductive layer

6—isolating substance

7—optical displacement sensor

8—processor

9—USB interface

### DETAILED DESCRIPTION OF EMBODIMENTS

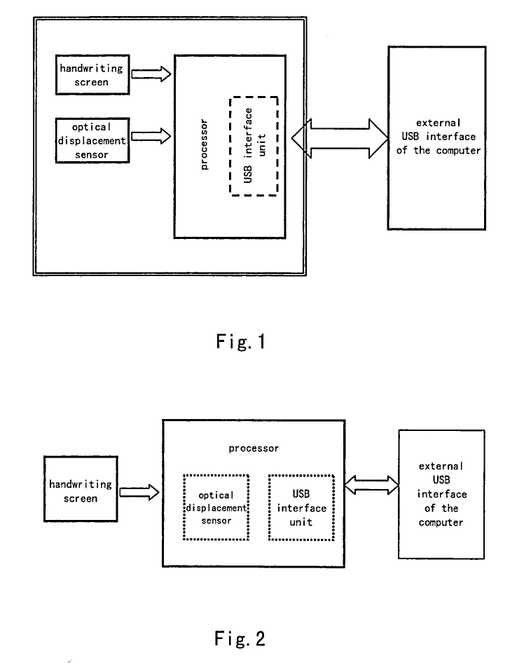

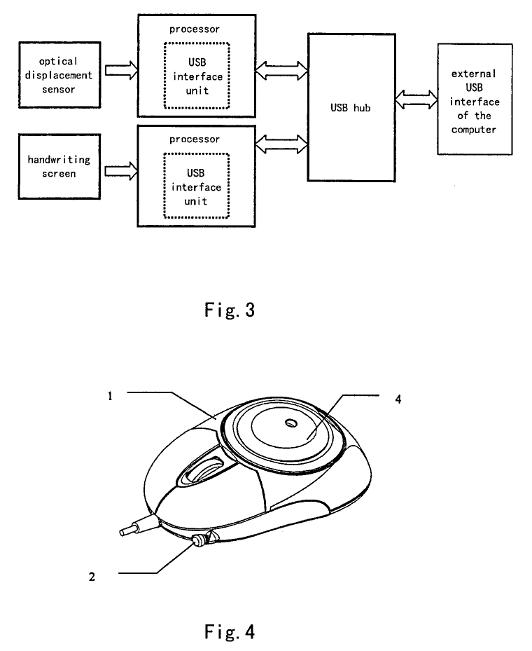

Hereafter, the present invention is further explained in detail with reference to the accompanying drawings and embodiments of the invention. FIG. 1 is the system schematic diagram of the preferred aspect of the present invention. It shows the specific connection relation among an optical displacement sensor, a handwriting screen, a processor and a USB interface unit that the processor is connected to the optical displacement sensor and the handwriting screen, respectively. The USB interface unit is embedded in the processor. The optical displacement sensor is used to acquire relative coordinate information when the apparatus moves, and the handwriting screen is used to acquire handwriting trace information. The processor transmits directly to an external computer the acquired relative coordinate information and the handwriting trace information through the embedded USB interface.

According to this embodiment, the optical displacement sensor is used to acquire relative coordinate information when the apparatus moves. When a mouse body is moving in a plane, the optical displacement sensor captures, in real-time, the planar image information at a speed of over 1500 frames per second. Next, the captured image information is processed by an embedded dedicated DSP processor, which is a digital signal processor, thereby obtaining the relative change relation of each image. The relative change relation is then converted to a relative movement parameter, i.e. the variable x and y values, which is transmitted to the computer through the USB interface of the processor to complete the cursor positioning function of the mouse in the present invention.

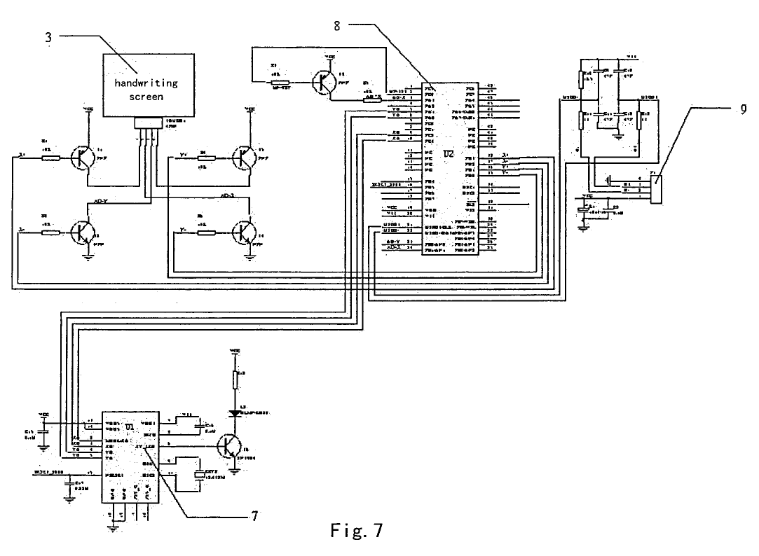

In this embodiment, the handwriting screen comprises a resistance composition screen formed of two conductive layers and the isolating substance sandwiched therebetween, as shown in FIG. 6. The handwriting screen may convert the acquired signals corresponding to writing trace to different voltage signals or current signals, and transmits them to the processor. After processing the handwriting trace information, the processor transmits it to the computer through the embedded USB interface so as to complete the handwriting input function in the present invention.

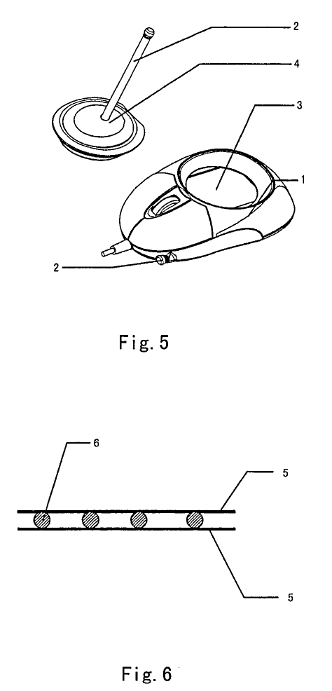

FIG. 4 is the profile drawing of this apparatus, and FIG. 5 is the use effect diagram of this apparatus. The structural body of this apparatus is divided into two parts including the mouse 1 and the handwriting screen 3. The handwriting screen 3 is arranged inside the mouse 3, and may be covered with a handwriting screen lid 4, or may be exposed. When only the mouse function of this apparatus is used, the handwriting screen lid 4 is disposed over the handwriting screen 3 as shown in FIG. 4. When both the mouse and handwriting input functions are used simultaneously, the handwriting screen lid 4 may be taken out from the top of the handwriting screen 3. The specific using manner of which is shown in FIG. 5.

This apparatus may be provided with a handwriting stylus 2 as a match to facilitate the handwriting input. The handwriting stylus 2 can be arranged either in the middle of the handwriting screen lid or both sides of the mouse. The handwriting stylus 2 may be inserted into the corresponding location inside the mouse 1 so as to be pull out when it is in use. It may also be inserted straightly to the corresponding part of the handwriting screen lid 4 as shown in FIG. 4.

In addition, the mouse 1 may be designed as flip-over cover type or pullout type, that is, the handwriting screen can be fixed to the inner side of the flip-over cover, or can be fixed to the sliding track inside the mouse to form a pullout handwriting screen.

FIG. 7 is the circuit diagram of the preferred aspect of the present inventive apparatus, in which the specific connection relation between the processor and the handwriting screen, the optical displacement sensor, the USB interface is in following manner. The pin 1 of the optical displacement sensor chip U1 is floating. The pin 2 of the chip U is connected to the pin 10 of the processor chip U2. The pin 3 of the chip U1 is connected to the pin 9 of the chip U2. The pin 4 of the chip U1 is connected to the pin 6 of the chip U2. The pin 5 of the chip U1 is connected to the pin 5 of the chip U2. The pin 6 of the chip U1 is connected to the base of the transistor T6. The emitter of the transistor T6 is grounded. The collector of the transistor T6 is connected to the cathode of the diode L2, and the anode of the diode L2 is connected in series with the resistor R18 and then connected to the power supply VCC. The pins 7 and 8 of the chip U1 are connected to both terminals of the capacitor C16, respectively. The pins 9 and 11 of the chip U1 are connected to both terminals of the electrolytic capacitor CRY2, respectively. The pins 10 and 12 of the chip U1 are connected in parallel and then grounded. The pin 16 of the chip U1 is floating. The pins 13 and 14 of the chip U1 are connected in parallel and then connected to the power supply VCC, while they are connected in series with the capacitor C15 and then grounded. The pins 15 and 17 of the chip U1 are connected in series and then grounded. The pin 1 of the processor chip U2 is floating. The pin 2 of the chip U2 is connected to one terminal of the resistor R3, and the other terminal of the resistor R3 is connected to the base of the transistor T3. The emitter of the transistor T3 is connected to the power supply VCC and the collector of the transistor T3 is connected to one terminal of the resistor R5 and the other terminal of which is connected to the pin 3 of the chip U2. The pins 4, 7, 8, 11, 12, 13, 14, 15, 17, 18 of the chip U2 are floating. The pin 16 of the chip U2 is connected to the pin 15 of the chip U1. The pin 19 of the chip U2 is connected to the power supply VCC. The pin 20 of the chip U2 outputs the voltage of 3.3V. The pin 21 of the chip U2 is connected respectively to each terminal of the resistor R12, the capacitors C12 and C10.

Here, the other terminal of the resistor R12 is connected to the pin 3 of the USB interface, the other terminal of the capacitor C12 is grounded, and the other terminal of the capacitor C10 is connected to the pin 20 of the chip U2. The pin 22 of the chip U2 is connected respectively to each terminal of the resistors R10 and R11, the capacitors C9 and C11. Here, the other terminals of the resistor R10 and the capacitor C9 are connected in parallel and connected to the pin 20 of the chip U2, and the other terminal of the capacitor C11 is grounded and the other terminal of the resistor R11 is connected to the pin 2 of USB interface. The pins 23 and 24 of the chip U2 are connected to the pins 3 and 2 of the interface TOUCH1, respectively. The pins 25 to 34 of the chip U2 are floating. The pin 35 of the chip U2 is connected to one terminal of the resistor R6, and the other terminal of the resistor R6 is connected to the base of the transistor T4. The emitter of the transistor T4 is grounded, the collector of the transistor T4 is connected to the pin 2 of the interface TOUCH1. The pin 36 of the chip U2 is connected to one terminal of the resistor R4, and the other terminal of which is connected to the base of the transistor T5. Here, the emitter of the transistor T5 is connected to the power supply VCC and the collector of the transistor T5 is connected to the pin 4 of the interface TOUCH1. The pin 37 of the chip U2 is connected to one terminal of the resistor R2, and the other terminal of which is connected to the base of the transistor T2. Here, the emitter of the transistor T2 is grounded and the collector of the transistor T2 is connected to the pin 3 of the interface TOUCH1. The pin 38 of the chip U2 is connected to one terminal of the resistor R1, and the other terminal of which is connected to the base of the transistor T1. Here, the emitter of the transistor T1 is connected to the power supply VCC and the collector of the transistor T1 is connected to the pin 1 of the interface TOUCH1. The pins 39 to 48 of the chip U2 are floating.

According to the second and third aspects of the present invention, the profiles and use effects of the designed apparatus can be the same as the above embodiment.

Moreover, the handwriting screen lid of the present invention can be provided with some simple devices commonly used, such as thermometer, compass and the like, to endow it with greater functionality and abundant practicability.

The present invention is convenient to use, accurate, reliable, and has no need to judge and wait for the operating states of the handwriting and the mouse, thereby increasing the speed. It is also durable, saves the space for placing the handwriting screen and has both the functions of handwriting and mouse with great practicability.

What is claimed is:

1. An apparatus having handwriting input and mouse functions comprises a mouse and a handwriting screen, wherein a handwriting screen is arranged in the mouse and the handwriting screen is connected to a processor in the mouse; and wherein an optical displacement sensor is connected to the processor, or may be also built in the processor, and a USB interface unit is connected to the processor, or may be also built in the processor.

2. The apparatus having handwriting input and mouse functions according to claim 1, wherein the handwriting screen arranged in the mouse may be either covered with a handwriting screen lid or exposed.

3. The apparatus having handwriting input and mouse functions according to claim 1, wherein a handwriting stylus is arranged in the middle of the handwriting screen lid or on both sides of the mouse.

4. The apparatus having handwriting input and mouse functions according to claim 1, wherein the structural body of the apparatus is divided into two parts including the mouse and the handwriting screen, respectively; and wherein the handwriting screen may be arranged in the mouse, and the mouse can be designed to be of a flip-over cover type or pullout type, in which the handwriting screen is fixed on the inner side of the flip-over cover, or on the sliding track to form a pullout handwriting screen.

5. The apparatus having handwriting input and mouse functions according to claim 1, wherein the handwriting screen comprises a resistance composition screen formed of two conductive layers and the isolating substance between them.

6. The apparatus having handwriting input and mouse functions according to claim 1, wherein there is a specific circuit connection relation among the optical displacement sensor, the handwriting screen, the processor and the USB interface unit, in which the pin (1) of the optical displacement sensor chip (U1) is floating; the pin (2) of the chip (U1) is connected to the pin (10) of the processor chip (U2); the pin (3) of the chip (U1) is connected to the pin (9) of the chip (U2); the pin (4) of the chip (U1) is connected to the pin 6 of the chip (U2); the pin (5) of the chip (U1) is connected to the pin (5) of the chip (U2); the pin (6) of the chip (U1) is connected to the base of the transistor (T6); the emitter of the transistor (T6) is grounded; the collector of the transistor (T6) is connected to the cathode of the diode (L2) and the anode of the diode (L2) is connected in series with the resistor (R18) and then connected to the power supply (VCC); the pins (7) and (8) of the chip (U1) are connected to both terminals of the capacitor (C16), respectively; the pins (9, 11) of the chip (U1) are connected to both terminals of the electrolytic capacitor (CRY2), respectively; the pins (10, 12) of the chip (U1) are connected in parallel and then grounded; the pin (16) of the chip (U1) is floating; the pins (13, 14) of the chip (U1) are connected in parallel and then connected to the power supply (VCC), and they are connected in series with the capacitor (C15) and then grounded; the pin (15) of the chip (U1) and capacitor (17) are connected in series and then grounded; the pin (1) of the processor chip (U2) is floating; the pin (2) of the chip (U2) is connected to one terminal of the resistor (R3); the other terminal of the resistor (R3) is connected to the base of the transistor (T3); the emitter of the transistor (T3) is connected to the power supply (VCC); the collector of the transistor (T3) is connected to one terminal of the resistor (R5) and the other terminal of which is connected to the pin (3) of the chip (U2); the pins (4, 7, 8, 11, 12, 13, 14, 15, 17, 18) of the chip (U2) is floating; the pin (16) of the chip (U2) is connected to the pin (15) of the chip (U1); the pin (19) of the chip (U2) is connected to the power supply (VCC); the pin (20) of the chip (U2) outputs the voltage of 3.3V; the pin (21) of the chip (U2) is connected respectively to each terminal of the resistor (R12) and the capacitors (C12, C10); the other terminal of the resistor (R12) is connected to the pin (3) of the USB interface; the other terminal of the capacitor (C12) is grounded, and the other terminal of the capacitor (C10) is connected to the pin (20) of the chip (U2); the pin (22) of the chip (U2) is connected respectively to each terminal of the resistors (R10, R11), the capacitors (C9, C11); the other terminals of the resistor (R10) and the capacitor (C9) are connected in parallel and then connected to the pin (20) of the chip (U2) and the other terminal of the capacitor (C11) is grounded, and the other terminal of the resistor (R11) is connected to the pin (2) of the USB interface; the pins (23, 24) of the chip (U2) are connected to the pins (3, 2) of the interface TOUCH1, respectively; the pins (25 34) of the chip (U2) are floating; the pin (35) of the chip (U2) is connected to one terminal of the resistor (R6) and the other terminal of which is connected to the base of the transistor (T4); the emitter of the transistor (T4) is grounded, the collector of the transistor (T4) is connected to the pin (2) of the interface TOUCH1; the pin (36) of the chip (U2) is connected to one terminal of the resistor (R4) and the other terminal of which is connected to the base of the transistor (T5), and the emitter of the transistor (T5) is connected to the power supply (VCC) and its collector is connected to the pin (4) of the interface TOUCH1; the pin (37) of the chip (U2) is connected to one terminal of the resistor (R2) and the other terminal of which is connected to the base of the transistor (T2), and the emitter of the transistor (T2) is grounded and its collector is connected to the pin (3) of the interface TOUCH1; the pin (38) of the chip (U2) is connected to one terminal of the resistor (R1) and the other terminal of which is connected to the base of the transistor (T1), and the emitter of the transistor (T1) is connected to the power supply (VCC) and the collector of which is connected to the pin (1) of the interface TOUCH1; the pins (39˜48) of the chip (U2) are floating.
